(19) United States
(12) Patent Application Publication
(10) Pub. No.: US 2019/0235810 A1
(43) Pub. Date: Aug. 1, 2019

(54) IMAGE FORMING SYSTEM AND IMAGE FORMING METHOD IN WHICH PLURAL IMAGE FORMING APPARATUSES, PLURAL USER TERMINALS, MANAGEMENT SERVER, AND DIRECTORY SERVER ARE CONNECTED VIA NETWORK

(71) Applicant: KYOCERA Document Solutions Inc., Osaka (JP)

(72) Inventors: Tatsuya HIWATARI, Osaka (JP); Masafumi SATO, Osaka (JP); Zhenyu SUN, Osaka (JP); Keiji TSUDA, Osaka (JP)

(73) Assignee: KYOCERA Document Solutions Inc., Osaka (JP)

(21) Appl. No.: 16/264,147

(22) Filed: Jan. 31, 2019

(30) Foreign Application Priority Data
Jan. 31, 2018 (JP) 2018-014945

(51) Int. Cl. G06F 3/12; G06F 21/60

(52) U.S. Cl. CPC G06F 3/1238; G06F 3/1222; G06F 3/1205; G06F 21/608

(57) ABSTRACT

Provided is an image forming system that reduces the time and labor of setting the printer driver of a user terminal. A common queue temporarily stores printing jobs transmitted from each user terminal. A plurality of individual queues is associated one-to-one with a plurality of image forming apparatuses. A printing-job-distributing unit distributes the printing jobs stored in the common queues to any of the plurality of individual queues. A printing-job-creation unit, based on the printer driver in which the output destination of the printing job is commonly set in the common queue, creates a printing job that includes a user name. The printing-job-distributing unit distributes the printing job to an individual queue based on the user name.

INCORPORATION BY REFERENCE

This application is based on and claims the benefit of priority from Japanese Patent Application No. 2018-014945 filed on Jan. 31, 2018, the contents of which are hereby incorporated by reference.

### BACKGROUND

The present disclosure relates to an image forming system and an image forming method in which a plurality of image forming apparatuses, a plurality of user terminals, a management server, and a directory server are connected via a network.

Conventionally, there has been known an image forming system in which a plurality of image forming apparatuses such as a printer or the like, user terminals such as a personal computer or the like, and a management server are connected via a network. In a typical technique, based on a printer driver installed in a user terminal, a printing job is transmitted from a user terminal to an image forming apparatus and executed after successfully authenticating the user by a management server.

### SUMMARY

The image forming system according to the present disclosure is an image forming system in which a plurality of user terminals that transmit printing jobs, a plurality of image forming apparatuses that execute the printing jobs, a management server, and a directory server are connected via a network. The management server includes a common queue, a plurality of individual queues, a printing-job-distributing unit, and a printing-job-transmitting unit. The common queue temporarily stores the printing jobs transmitted from each of the user terminals. The plurality of individual queues is associated one-to-one with the plurality of image forming apparatuses. The printing-job-distributing unit distributes the printing jobs stored in the common queue to any of the plurality of individual queues. The printing-job-transmitting unit transmits the printing jobs stored in the individual queues to the image forming apparatuses associated with the individual queues. Each of the plurality of user terminals includes a printing-job-creation unit. The printing-job-creation unit, based on the printer driver in which the output destination of the printing job is commonly set in the common queue, creates the printing job that includes a user name. The directory server includes an individual-queue-setting-receiving unit, and an individual-queue-notifying unit. The individual-queue-setting-receiving unit receives the settings of the individual queues as the output destinations of the printing jobs for each user. The individual-queue-notifying unit, in the case where there is an inquiry about the individual queue of a user, gives notification about the individual queue received by the individual-queue-setting-receiving unit. The printing-job-distributing unit of the management server makes an inquiry to the directory server about the individual queue based on the user name included in the printing job in the common queue, and distributes the printing job to the individual queue notified from the directory server.

The image forming method according to the present disclosure is an image forming method that is executed by an image forming system in which a plurality of user terminals that transmit printing jobs, a plurality of image forming apparatuses that execute the printing jobs, a management server, and a directory server are connected via a network. The management server temporarily stores the printing jobs transmitted from each of the user terminals in a common queue. The management server distributes the printing jobs stored in the common queue to any of a plurality of individual queues associated one-to-one with the plurality of image forming apparatuses. The management server transmits the printing jobs stored in the individual queues to the image forming apparatuses associated with the individual queues. Each of the plurality of user terminals, based on the printer driver in which the output destination of the printing job is commonly set in the common queue, creates the printing job that includes a user name. The directory server receives the setting of the individual queue of each user. The directory server, in the case where there is an inquiry about the individual queue of a user, gives notification about the individual queue of which the setting is received. The management server makes an inquiry to the directory server about the individual queue based on the user name included in the printing job in the common queue, and distributes the printing job to the individual queue notified from the directory server.

### BRIEF DESCRIPTION OF THE DRAWINGS

FIG. 1 is a system configuration diagram of an image forming system according to an embodiment of the present disclosure.

FIG. 2 is a schematic configuration diagram of the user terminal illustrated in FIG. 1.

FIG. 3 is a schematic configuration diagram of the management server illustrated in FIG. 1.

FIG. 4 is a schematic configuration diagram of the directory server illustrated in FIG. 1.

FIG. 5 illustrates an example of registration of the individual queue setting information illustrated in FIG. 2.

FIG. 6 is a flowchart illustrating the flow of a printing process of the image forming system illustrated in FIG. 1.

### DETAILED DESCRIPTION

Embodiments according to the present disclosure will be described in detail below with reference to the drawings. Incidentally, in the following embodiments, the same reference numerals are given to configuration showing similar functions.

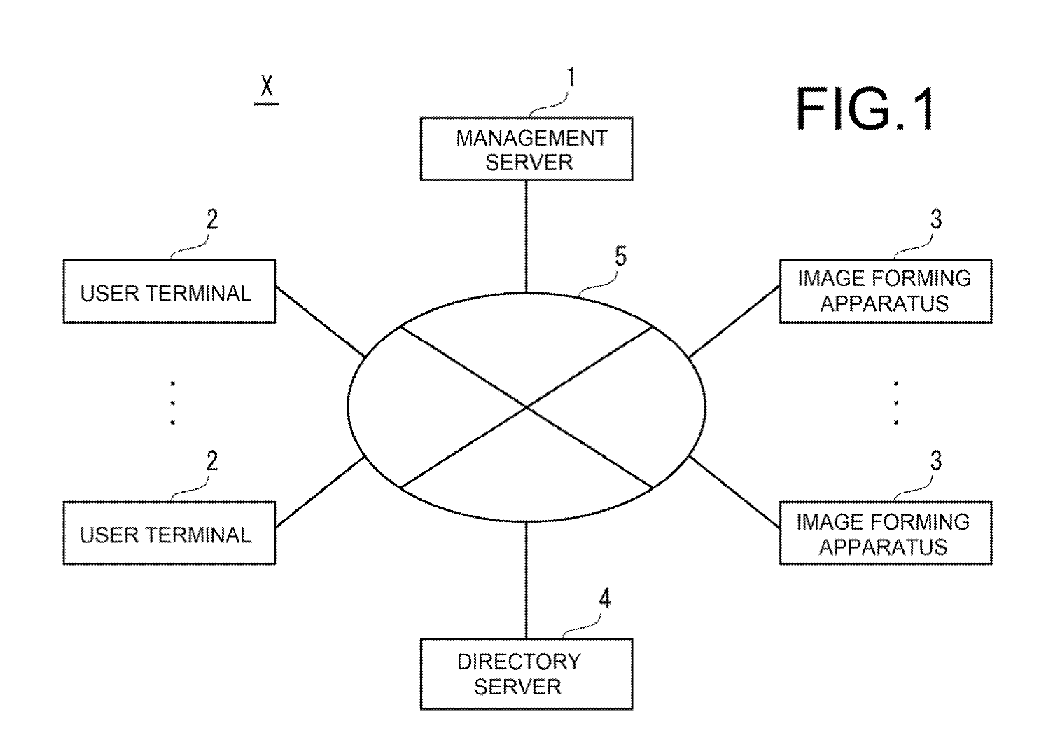

As illustrated in FIG. 1, in an image forming system X, a management server 1, a plurality of user terminals 2, a plurality of image forming apparatuses 3, and a directory server 4 are connected via a network 5. The image forming apparatus 3 is a printer, a copying machine, a multifunction peripheral, or the like, and has a printing function.

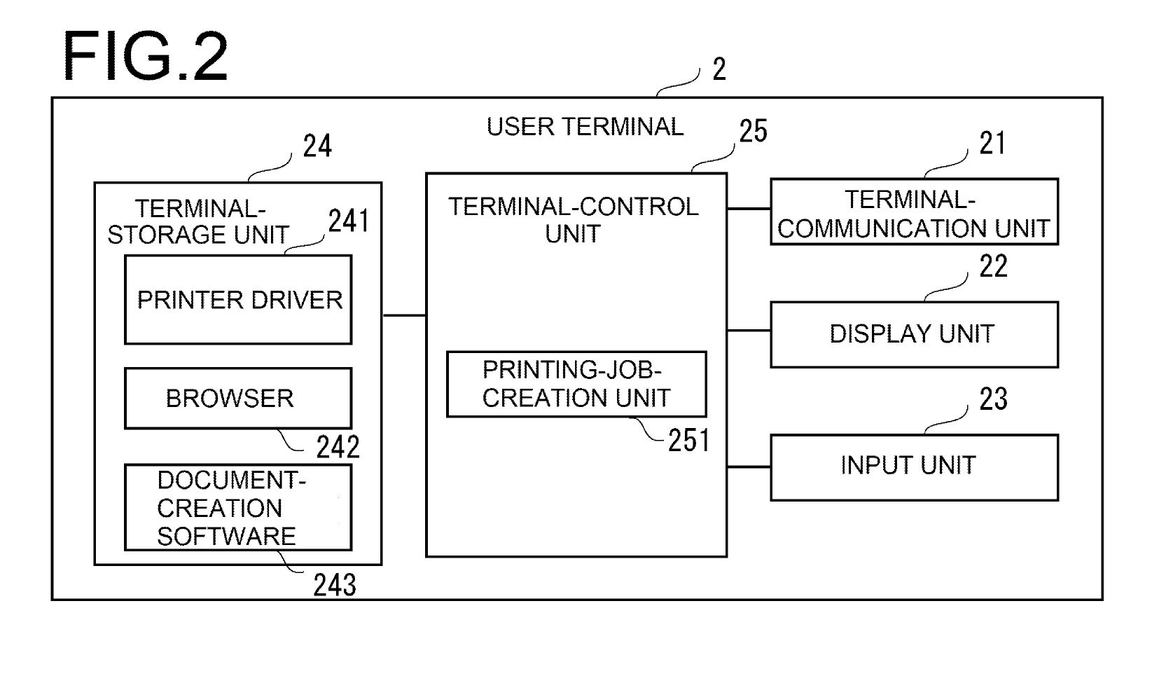

A schematic configuration of the user terminal 2 will be described with reference to FIG. 2.

The user terminal 2 is, for example, a personal computer, a tablet terminal, a smartphone, or the like, and includes a terminal-communication unit 21, a display unit 22, an input unit 23, a terminal-storage unit 24, and a terminal-control unit 25.

The terminal-communication unit 21 has a function for transmitting and receiving various data to and from the management server 1 via a network 5 such as a LAN (Local Area Network), the Internet, or the like.

The display unit 22 is a display unit such as a display or the like for displaying various kinds of information.

The input unit 23 is an input unit such as a mouse, a keyboard, a pointing device, or the like. The input unit 23 may be provided as a transparent touch sensor on the display surface of the display unit 22. The input unit 23 may function as a touch panel together with the display unit 22. In addition, the input unit 23 may read an IC card such as an employee identification, or the like and acquire authentication information such as a user name or the like.

The terminal-storage unit 24 is a storage unit such as a semiconductor memory, a HDD (Hard Disk Drive), or the like, and stores a printer driver 241, a browser 242, and document-creation software 243.

The printer driver 241 is an application program for creating a printing job according to an operation instruction that is inputted from the input unit 23, and transmitting the created printing job to the management server 1 by the terminal-communication unit 21. The output destinations of the printing jobs of the printer drivers 241 installed in each of the plurality of user terminals 2 are commonly set in a common queue 121 of the management server 1. Therefore, a service person can deploy the printer drivers 241 collectively to the plurality of user terminals 2, and there is no need to change the setting of the output destination for each individual printer driver. A printer driver 241 is in an installed state in a user terminal 2.

The browser 242 is an application program for displaying a web page that is in HTML format or the like on the display unit 22.

The document-creation software 243 is, for example, an application program for viewing, editing and creating document data in Word (registered trademark) format or the like of Microsoft corporation (registered trademark).

A startup operation of the browser 242 or the document-creation software 243 is performed via the input unit 23. Then, the terminal-control unit 25 reads the browser 242 and the document-creation software 243 stored in the terminal-storage unit 24, develops them in the RAM, and executes them, thereby activating the browser 242 and the document-creation software 243. As a result, the user can perform browsing, editing, and the like by causing the display unit 22 to display image data, HTML data, document data, and the like (hereinafter referred to as “document data”) by using the browser 242 or the document-creation software 243.

The terminal-control unit 25 is an information processing unit such as a microcomputer or the like that includes a CPU (Central Processing Unit), ROM (Read Only Memory), RAM (Random Access Memory), and the like. The ROM stores a control program for performing operation control of the user terminal 2. The CPU of the terminal-control unit 25 reads the control program stored in the ROM, develops the control program in the RAM, and executes the control program, thereby controlling the entire user terminal 2. In addition, the terminal-control unit 25 functions as a printing-job-creation unit 251.

The printing-job-creation unit 251 has a function of creating a printing job that causes the document data to be printed in the case where an instruction is given to print document data being viewed or edited using the browser 242 or the document-creation software 243. In the case where there is an instruction to print document data, the terminal-control unit 25 reads the printer driver 241 stored in the terminal-storage unit 24, develops the printer driver 241 in the RAM, and executes the printer driver 241, thereby activating the printer driver 241. As a result, the terminal-control unit 25 functions as a printing-job-creation unit 251 that achieves the function of the printer driver 241. The printing-job-creation unit 251, before transmitting a printing job, causes the management server 1 to log in the user, then transmits the printing job including the user name.

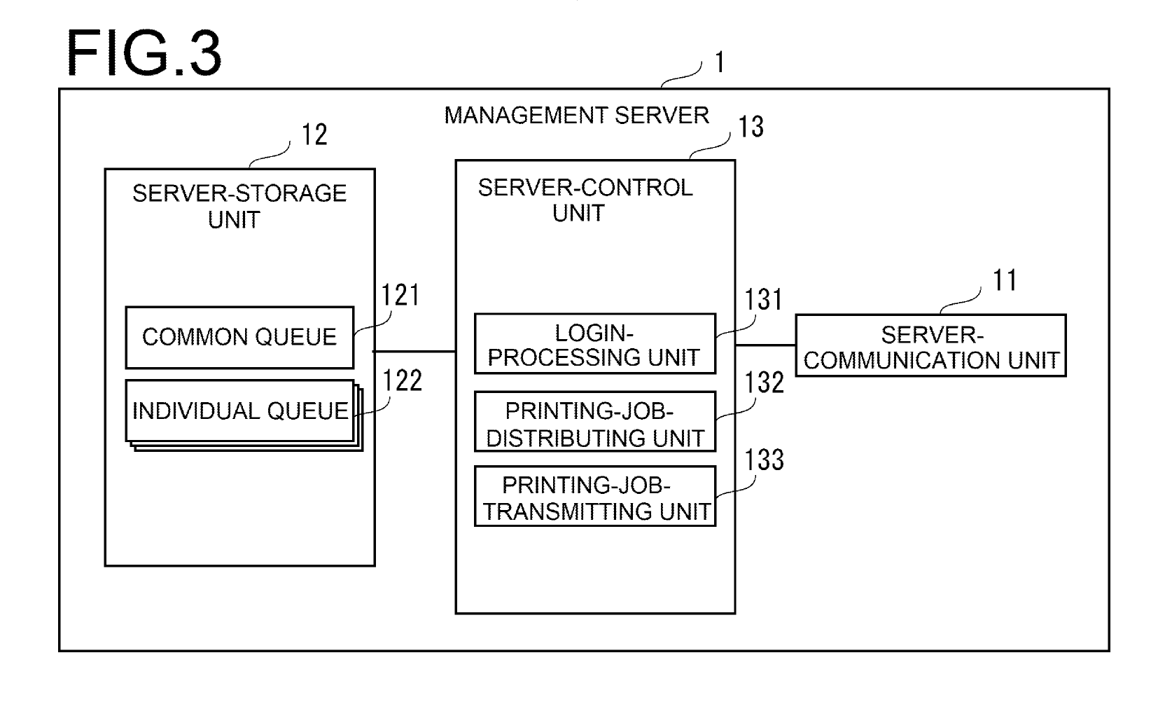

Next, a schematic configuration of the management server 1 will be described with reference to FIG. 3. The management server 1 includes a server-communication unit 11, a server-storage unit 12, and a server-control unit 13.

The server-communication unit 11 has a function for transmitting and receiving various data to and from a plurality of user terminals 2, a plurality of image forming apparatuses 3, and a directory server 4 via a network 5 such as a LAN, the Internet, or the like.

The server-storage unit 12 is a storage unit such as a semiconductor memory, an HDD, or the like, and includes a common queue 121 and a plurality of individual queues 122 that are associated one-to-one with the plurality of image forming apparatuses 3. In addition, the server-storage unit 12 stores various setting files such as config.ini files and the like.

The common queue 121 is a queue in which printing jobs transmitted from each user terminal 2 are temporarily stored. All of the printing jobs transmitted from each of the plurality of user terminals 2 are temporarily stored in the common queue 121.

The number of the plurality of individual queues 122 provided is the same as the number of the plurality of image forming apparatuses 3 to be managed by the management server 1, and the plurality of individual queues 122 corresponds to the plurality of image forming apparatuses 3 on a one-to-one basis.

The server-control unit 13 is an information processing unit such as a microcomputer or the like that includes a CPU, a ROM, a RAM and the like. The ROM stores a control program for performing operation control of the management server 1. The CPU of the server-control unit 13 reads the control program stored in the ROM, develops the control program in the RAM, and executes the control program, thereby performing overall control of the management server 1.

In addition the server-control unit 13 functions as a login-processing unit 131, a printing-job-distributing unit 132, and a printing-job-transmitting unit 133.

When authentication information such as a user name (user ID), password, and the like is transmitted from the user terminal 2, the login-processing unit 131 performs user authentication in cooperation with the directory server 4. Then, the login-processing unit 131 logs in a user who succeeded in user authentication. The login-processing unit 131 has these functions.

The printing-job-distributing unit 132 monitors the storage state of the printing jobs in the common queue 121. In the case where a printing job is stored in the common queue 121, the printing-job-distributing unit 132 inquires of the directory server 4 about the individual queue 122 of the user based on the user name included in the printing job. Then, the printing-job-distributing unit 132 distributes the printing job to the individual queue 122 notified from the directory server 4. The printing-job-distributing unit 132 has these functions.

The printing-job-transmitting unit 133 monitors the storage state of the printing jobs of each individual queue 122. The printing-job-transmitting unit 133, via the server-communication unit 11, transmits the printing jobs stored in each individual queue 122 to image forming apparatuses 3 corresponding to the individual queues 122. The printing-job-transmitting unit 133 has these functions.

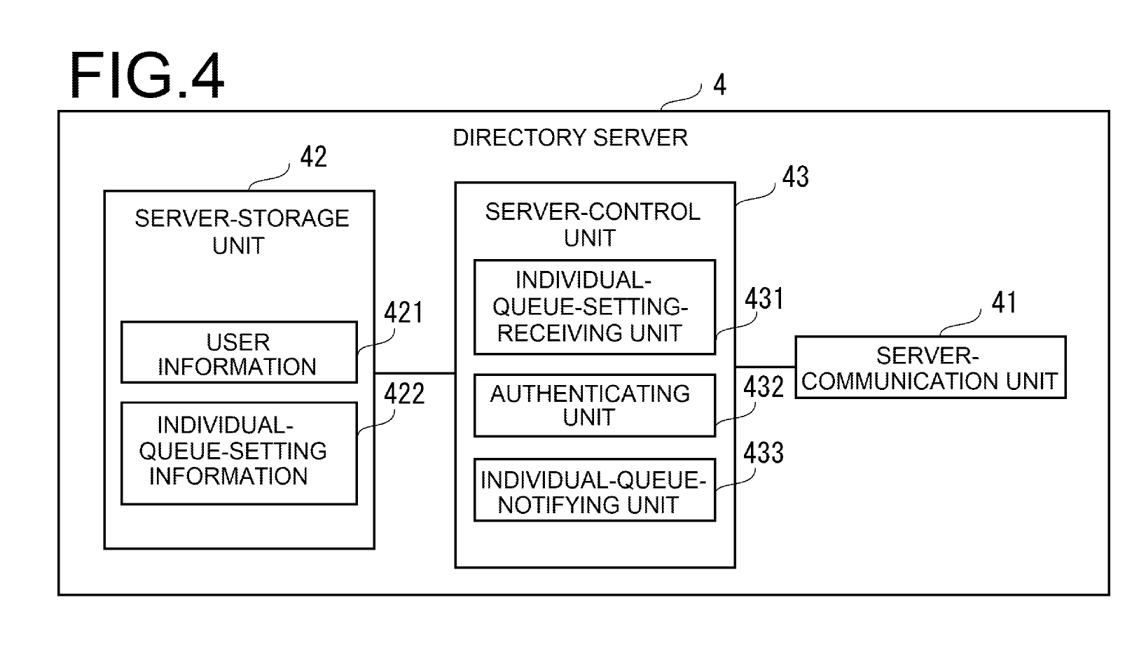

Next, a schematic configuration of the directory server 4 will be described with reference to FIG. 4.

The directory server 4 is a server that provides a directory service using LDAP (Lightweight Directory Access Protocol), Active Directory (registered trademark), or the like. The directory server 4 includes a server-communication unit 41, a server-storage unit 42, and a server-control unit 43.

The server-communication unit 41 has a function for transmitting and receiving various data to and from the management server 1 via a network 5 such as a LAN, the Internet, or the like.

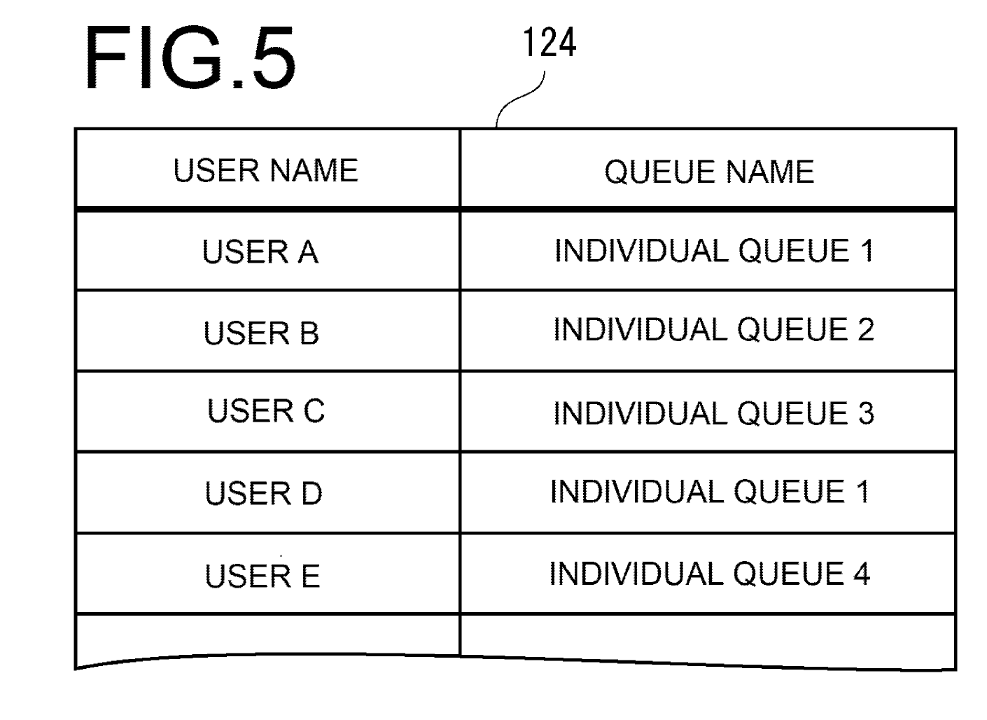

The server-storage unit 42 is a storage unit such as a semiconductor memory, an HDD, or the like, and stores user information 421 and individual-queue-setting information 422. The user information 421 registers a user name (user ID), a password, and the like used for user authentication. The individual-queue-setting information 422, as illustrated in FIG. 5, registers an individual queue 122 corresponding to an image forming apparatus 3 as the output destination of each user.

The server-control unit 43 is an information processing unit such as a microcomputer or the like including a CPU, a ROM, a RAM and the like. The ROM stores a control program for performing operation control of the directory server 4. The CPU of the server-control unit 43 reads the control program stored in the ROM, develops the control program in the RAM, and executes the control program, thereby performing overall control of the directory server 4. In addition, the server-control unit 43 functions as an individual-queue-setting-receiving unit 431, an authenticating unit 432, and an individual-queue-notification unit 433.

The individual-queue-setting-receiving unit 431, with administrator authority, has a function for receiving the settings of individual queues 122 as the output destinations of printing jobs of each user and registering the settings in the individual-queue-setting-information 422.

For example, an administrator logs in with administrator authority to the directory server 4 via an administrator terminal, and via the individual-queue-setting-receiving unit 431, can set the individual queues 122 of each of the users registered in the user information 421 in the queue-setting information 422. As a result, the administrator is able to unitarily manage individual queues of each user. In addition, since it is not necessary for each user to individually set an individual queue, it is possible to suppress human errors. Incidentally, setting of the individual queue 122 may be performed via an external file such as a CSV file or the like in which correspondence between each user and each individual queue 122 is described. The individual-queue-setting-receiving unit 431 receives a setting of an individual queue 122 by acquiring a file specified by an administrator, and causes the correspondence between the user described in the acquired external file and the individual queue 122 to be reflected in the individual-queue-setting information 422.

The authenticating unit 432 has the function of performing user authentication by comparing authentication information such as a user name, a password and the like transmitted from the management server 1 via the server communication unit 41 with the user information 421, and transmitting the authentication result to the management server 1.

The individual-queue-notifying unit 433 has a function of referring to the individual-queue-setting information 422 and notifying the management server 1 about an individual queue 122 associated with a user name for which there is an inquiry from the management server 1. This is the case when there is an inquiry about an individual queue 122 corresponding to a user name from the management server 1 via the server-communication unit 41.

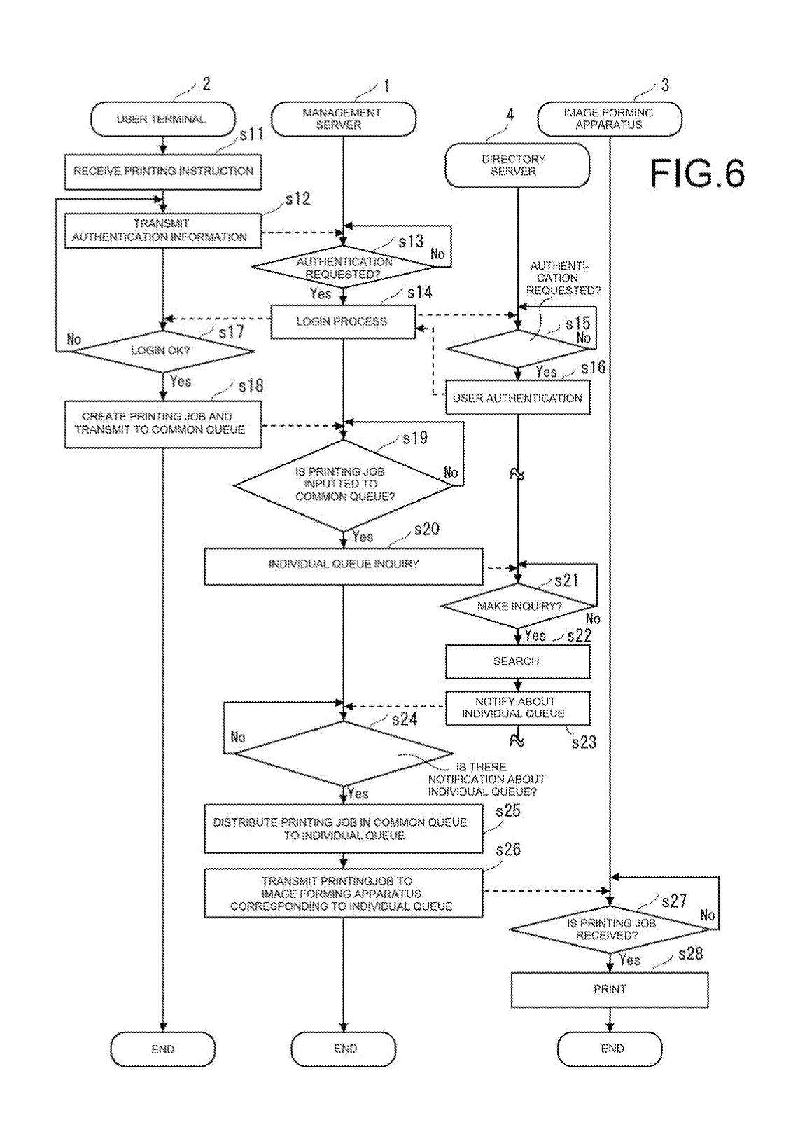

Next, the flow of a printing process by the image forming system X will be described with reference to FIG. 6. Note that in the individual-queue-setting information 422 of the directory server 4, it is assumed that an individual queue 122 is registered for each user.

Upon receiving a printing instruction from a user via the input unit 23 (S11), the printing-job-creation unit 251 of the user terminal 2 transmits authentication information such as a user name and the like inputted via the input unit 23 to the management server 1 by a terminal-communication unit 21 (S12).

The login-processing unit 131 of the management server 1 waits in standby until an authentication request is received from a user terminal 2 (S13, S13: NO), and in the case where there is an authentication request (S13: YES), executes a login process based on authentication information transmitted from the user terminal 2 (S14).

The login process is performed in cooperation with the directory server 4. The login-processing unit 131 transmits the authentication information transmitted from the user terminal 2 to the directory server 4 via the server-communication unit 11 and performs an authentication request. The authentication unit 432 of the directory server 4 waits in standby until there is an authentication request (S5, S15: NO). When an authentication request for authentication information is transmitted from the management server 1 (S15: YES), user authentication is performed by comparing the transmitted authentication information with the user information 421 (S16). The user authentication result by the authentication unit 432 is transmitted to the management server 1 via the server-communication unit 41.

In the login process, the login-processing unit 131 of the management server 1 logs in the user who succeeded in user authentication by the directory server 4 and notifies the user terminal 2 of the login result.

Based on the login result notified from the management server 1, the printing-job-creation unit 251 of the user terminal 2 determines whether or not the login is OK (S17). In the case where the login fails (S17: NO), the printing-job-creation unit 251 may return the process to S12 to transmit the authentication information and prompt the user to log in again.

On the other hand, in the case where the login is OK (S17: YES), the printing-job-creation unit 251 creates a printing job based on a printing instruction and transmits the printing job to the common queue 121 of the management server by the terminal-communication unit 21 (S18). At this time, the printing-job-creation unit 251 transmits the printing job that includes the logged-in user name to the common queue 121.

The printing-job-distributing unit 132 of the management server 1 waits in standby until a printing job is inputted to the common queue 121 (S19, S19: NO). Since all output destinations of the printer drivers 241 installed in each of the user terminals 2 are set in the common queue 121, all printing jobs received from the user terminals 2 by the server-communication unit 11 are stored in the common queue 121.

When a printing job is inputted to the common queue 121 (S19: YES), the printing-job-distributing unit 132, via the server-communication unit 11, makes an inquiry to the directory server 4 about the individual queue 122 corresponding to the user name included in the printing job (S20).

The individual-queue-notifying unit 433 of the directory server 4 waits in standby until there is inquiry about the individual queue 122 from the management server 1 (S21, S21: NO). In the case where there is an inquiry about the individual queue 122 (S21: YES), the individual-queue-notifying unit 433 searches for the individual queue 122 associated with the inquiried user name from the individual-queue-setting information 422 (S22). Continuing, the individual-queue-notifying unit 433, via the server-communication unit 41 notifies the management server 1 of the individual queue 122 found by the search (S23).

The printing-job distributing unit 132 of the management server 1 waits in standby until there is a notification from the individual-queue-notifying unit 433 of the directory server 4 about the individual queue 122 (S24, S24: NO). In the case where there is a notification about the individual queue 122 (S24: YES), the printing-job-distributing unit 132 distributes the printing job of the user stored in the common queue 121 to the individual queue 122 notified from the directory server 4 (S25). As a result, the printing job of the user is moved from the common queue 121 to the individual queue 122.

Continuing, the printing-job-transmitting unit 133 of the management server 1 transmits the printing job stored in the individual queue 122 to the image forming apparatus 3 corresponding to the individual queue 122 by the server-communication unit 11 (S26).

The image forming apparatus 3 waits in standby until receiving the printing job (S27, S27: NO), and upon receiving the printing job (S27: YES), executes the printing job and prints (S28). This completes this process.

In this way, a printing job is transmitted from the user terminal 2 and is distributed to the individual queue 122 via the common queue 121 of the management server 1, then transmitted to the image forming apparatus 3 corresponding to the individual queue 122 and executed. Therefore, even when the output destination of the printer driver 241 of each user terminal 2 is set commonly to the common queue 121, it is possible to perform direct printing of printing jobs of each user from the image forming apparatus 3 of the individual queue 122 associated with each user.

In this way, the image forming system X is an image forming system X in which a plurality of user terminals 2 that transmit printing jobs, a plurality of image forming apparatuses 3 that execute printing jobs, a management server 1, and a directory server 4 are connected via a network 5; wherein the management server 1 includes: a common queue 121 for temporarily storing printing jobs transmitted from each user terminal 2; a plurality of individual queues 122 associated one-to-one with the plurality of image forming apparatuses 3; a printing-job-distributing unit 132 for distributing the printing jobs stored in the common queue 121 to any of the plurality of individual queues 122; and a printing-job-transmitting unit 133 that transmits the printing jobs stored in the individual queues 122 to the image forming apparatuses 3 associated with the individual queues 122; each of the plurality of user terminals 2 includes a printing-job-creation unit 251 that, based on the printer driver 241 in which the output destination of the printing job is commonly set in the common queue 121, creates a printing job that includes a user name; the directory server 4 includes: an individual-queue-setting-receiving unit 431 for receiving the settings of the individual queues 122 as the output destinations of the printing jobs for each user; and an individual-queue-notifying unit 433 that, in the case where there is an inquiry about an individual queue 122 of a user, gives notification about the individual queue received by the individual-queue-setting-receiving unit 431; and the printing-job-distributing unit 132 of the management server 1 makes an inquiry to the directory server 4 about an individual queue 122 based on the user name included in the printing job in the common queue 121, and distributes the printing job to the individual queue 122 notified from the directory server 4.

As a result, printing jobs that are transmitted from each user terminal 2 are temporarily stored in the common queue 121 of the management server 1, and the printing-job-distributing unit 132 distributes the printing jobs to the individual queues 122 associated with the users who created the printing jobs. Then, the printing-job-transmitting unit 133 transmits a printing job to an image forming apparatus 3 corresponding to an individual queue 122, and the printing job is printed by the image forming apparatus 3. Therefore, it is possible to set the output destination of the printer driver 241 of each user terminal 2 in the common queue 121. Therefore, when applying the image forming system X to a large-scale customer, it is possible to save time and labor required for a service person to change the setting of each of the printer drivers 241 installed in thousands or tens of thousands of user terminals 2, and thus it is possible to provide the forming system X at low cost.

In addition, before transmitting a printing job to an image forming apparatus 3 corresponding to an individual queue 122, the printing-job-transmitting unit 133 of the management server 1 may determine whether or not the printing setting of the printing job to be transmitted is such that printing is possible by the image forming apparatus 3 of the transmission destination. Then, in the case where printing is not possible, the printing-job transmitting unit 133 does not transmit the printing job to the image forming apparatus 3, and by e-mail or the like notifies the user who created the printing job that the printing setting is inappropriate. Moreover, instead of the printing-job-transmitting unit 133 determining whether or not printing is possible, the image forming apparatus 3 may determine whether or not it is possible to print a printing job that is transmitted from the printing-job-transmitting unit 133. Then, in the case where printing is not possible, the image forming apparatus 3 may, by e-mail or the like, notify the user who created the printing job that the printing setting is inappropriate.

In a typical technique, it is necessary to set the image forming apparatus that will be the output destination of a printing job in the setting of the printer driver. Therefore, in the case of providing an image forming system to a customer, when a service person installs a printer driver on each user terminal, there is a problem in that it is necessary to individually set the image forming apparatuses of the output destinations, which is very troublesome.

With the technique according to the present disclosure, it is possible to reduce the time and labor of setting the printer drivers of the user terminals.

The technique according to the present disclosure is not limited to the above-described embodiments, and it goes without saying that various modifications can be made within a range that does not depart from the gist of the present disclosure.

What is claimed is:

1. An image forming system in which a plurality of user terminals that transmit printing jobs, a plurality of image forming apparatuses that execute the printing jobs, a management server, and a directory server are connected via a network; wherein
the management server comprises:
a common queue for temporarily storing the printing jobs transmitted from each of the user terminals;
a plurality of individual queues associated one-to-one with the plurality of image forming apparatuses;
a printing-job-distributing unit for distributing the printing jobs stored in the common queues to any of the plurality of individual queues; and
a printing-job-transmitting unit that transmits the printing job stored in the individual queue to the image forming apparatuses associated with the individual queues;
each of the plurality of user terminals comprises
a printing-job-creation unit that, based on the printer driver in which the output destination of the printing job is commonly set in the common queue, creates the printing job that includes a user name;
the directory server comprises:
an individual-queue-setting-receiving unit for receiving the settings of the individual queues as the output destinations of the printing jobs for each user; and
an individual-queue-notifying unit that, in the case where there is an inquiry about the individual queue of a user, gives notification about the individual queue received by the individual-queue-setting-receiving unit; and
the printing-job-distributing unit of the management server
makes an inquiry to the directory server about the individual queue based on the user name included in the printing job in the common queue, and distributes the printing job to the individual queue notified from the directory server.

2. The image forming system according to claim 1, wherein
the individual-queue-setting-receiving unit
receives the setting of the individual queue of the user based on an external file that associates the user and the individual queue.

3. An image forming method that is executed by an image forming system in which a plurality of user terminals that transmit printing jobs, a plurality of image forming apparatuses that execute the printing jobs, a management server, and a directory server are connected via a network; whereby
the management server
temporarily stores the printing jobs transmitted from each of the user terminals in a common queue;
distributes the printing jobs stored in the common queue to any of a plurality of individual queues associated one-to-one with the plurality of image forming apparatuses; and
transmits the printing jobs stored in the individual queues to the image forming apparatuses associated with the individual queues;
each of the plurality of user terminals,
based on the printer driver in which the output destination of the printing job is commonly set in the common queue, creates the printing job that includes a user name;
the directory server
receives the setting of the individual queue of each user; and
in the case where there is an inquiry about the individual queue of a user, gives notification about the individual queue of which the setting is received; and
the management server
makes an inquiry to the directory server about the individual queue based on the user name included in the printing job in the common queue, and distributes the printing job to the individual queue notified from the directory server.
